(19) United States
(12) Patent Application Publication
(10) Pub. No.: US 2010/0139268 A1
(43) Pub. Date: Jun. 10, 2010

(54) Internal Combustion Engine with Two Chargers and Method for Operating Same

(75) Inventors: Frank HUBER, Waldsee (DE); Markus SONNER, Koesching (DE); Guido EHLERS, Wettstetten (DE)

Correspondence Address: Novak Druce & Quigg LLP, 1300 I Street NW, Suite 1000 West Tower, Washington, DC, 20005, US

(73) Assignee: Audi AG, Ingolstadt (DE)

(21) Appl. No.: 12/566,420

(22) Filed: Sep. 24, 2009

(30) Foreign Application Priority Data
Sep. 24, 2008 (DE) 102008048681.7

(51) Int. Cl. F02D 23/00; F02B 33/44

(52) U.S. Cl. 60/602; 60/612

(57) ABSTRACT

The invention relates to an internal combustion engine with at least one cylinder which has at least two exhaust valves which are connected to exhaust gas lines in which there are the turbines of the exhaust gas turbochargers which have compressors for the charging air of internal combustion engines. It is provided that downstream from the compressors there is a merge (23) for the charging air flows (21) of the compressors and that there is at least one externally controllable valve (25) downstream from at least one of the compressors and upstream from the merge (23).

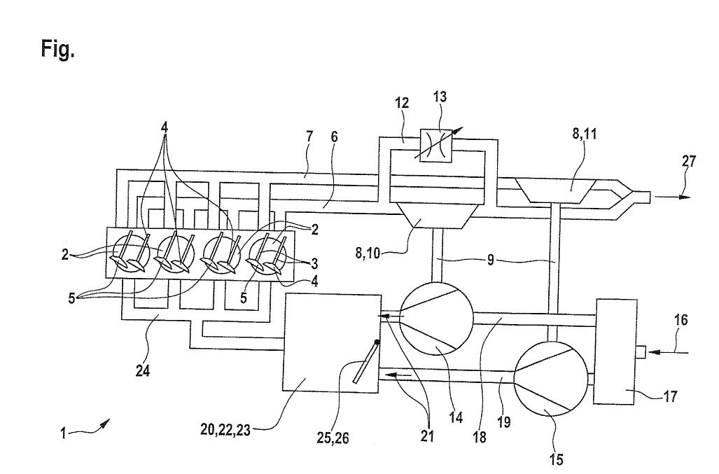

Furthermore, the invention relates to a method for operating such an internal combustion engine. It is provided that downstream from the compressors the charging air flows of the compressors are merged and that at least downstream from one of the compressors and upstream from the merge, externally controllable blocking or choking of at least one of the charging air flows can take place.

The invention relates to an internal combustion engine with at least one cylinder which has at least two exhaust valves which are connected to exhaust gas lines in which there are the turbines of the exhaust gas turbochargers which have compressors for the charging air of internal combustion engines.

The invention furthermore relates to a method for operating such an internal combustion engine.

In the prior art, internal combustion engines are known which have at least two exhaust valves per cylinder, the exhaust valves being assigned to different exhaust gas lines, and each exhaust gas line having one turbine of the exhaust gas turbocharger which is assigned to a compressor for charging air of the internal combustion engine. To operate the exhaust gas turbochargers the exhaust valves are triggered in such a manner that in low load or partial load operation one exhaust valve is closed so that only the turbine of the exhaust gas turbocharger runs which is located in the exhaust gas line whose assigned exhaust valves are opened. For torque demands and, in particular, in full load operation the other exhaust valves are also opened and are connected to the further exhaust gas line, so that the exhaust gas turbocharger assigned to the latter starts operation and delivers charging air for the internal combustion engine. In low load or partial load operation therefore only one of the two exhaust gas turbochargers is used, while in full load operation or for sudden torque demand the two exhaust gas turbochargers are started. The second exhaust gas turbocharger is started in this process by opening of the other exhaust valves which are assigned to the respective exhaust gas line. Such an arrangement is known, for example, from DE 10 2005 055 996 and from EP 1 645 735 A1.

In these embodiments it is disadvantageous that the charging air, with the second exhaust gas turbocharger inactive (that is, closed second exhaust valves), which is delivered by the first exhaust gas turbocharger to the intake manifold can leak from the region of the intake manifold opposite the intended flow direction into the region of the compressor of the second exhaust gas turbocharger and leads to unwanted pressure drops and loss of charging air and thus to irregularities in operating behavior. To avoid this, arrangements are known in which downstream from the second compressor there is a nonreturn valve which opens with a specific hysteresis after starting of the second compressor by opening the second exhaust valves and activating the second turbine which is assigned to the second compressor. In this way an unwanted pressure irregularity occurs, for example, an unwanted pressure surge when the nonreturn valve opens when a give pressure threshold is reached at a given delivery rate of the second compressor which leads to an almost abrupt change of torque in the operation of the internal combustion engine. The build-up of torque in the internal combustion engine takes place in an uncomfortable manner which may even be unpleasant for the driver under certain circumstances, and for very high performance internal combustion engines the manageability of the vehicle can suffer under highly unfavorable operating conditions.

The object of the invention is to make available an internal combustion engine of the generic type which avoids the indicated disadvantages and to make available a method for its operation.

For this purpose, an internal combustion engine is proposed with at least one cylinder having at least two exhaust valves which are connected to exhaust gas lines in which there are the turbines of exhaust gas turbochargers which have compressors for the charging air of the internal combustion engine. It is provided that downstream from the compressors there is a merge for the charging air flows of the compressors and that there is at least one externally controllable valve downstream from at least one of the compressors and upstream from the merge. Starting the individual compressors or the turbines of the exhaust gas turbochargers which drive them takes place conventionally in that the exhaust valves are opened which are assigned to the respective (in particular second) exhaust gas turbocharger and its exhaust gas line. In this way, the exhaust gas turbocharger starts operation by supplying exhaust gas to its turbine, as a result of which the compressor begins to deliver charging air. The charging air flows of the compressors are merged in a merge which is located downstream from the compressors. Downstream from at least one of the compressors and upstream from this merge, there is a valve which can be externally controlled, that is to say, the said valve in particular is not dependent on the charging air flow and its back-pressure which prevails on the valve and that the control allows this at least one charging air flow with respect to the volumetric or mass throughput of charging air. This valve, in this case, is triggered externally, in particular specifically by way of an existing engine control, for example an engine control device known from the prior art.

In one embodiment it is provided that the valve is designed as an air damper. Air dampers make it possible to not only block or release the charging air flow, but especially also to vary it in a preferably smooth manner. In this connection, air dampers can be made in a very streamlined manner, specifically, in particular such that unwanted swirling of the charging air in the charging air flow is eliminated or reduced in the region of the air damper.

It is preferably provided that the merge has an air merging space in which the valve is located. The merge, accordingly, has an air merging space for purposes of merging the charging air flows. The valve is located in this space.

Preferably, there is a valve made as an air damper in the air merging space.

In one especially preferred embodiment, the valve, designed as an air damper, is located in the air merging space such that selectively the charging air flow coming from one compressor and the charging air flow coming from the other compressor can be blocked or choked or that the two charging air flows can be released. The valve made as the air damper can accordingly block, release or choke the charging air flow of each compressor. It is, for example, possible to completely release the charging air flow of the first compressor and to continuously release the charging air flow of the second compressor out of the initially blocked state, i.e., to open the air damper ever wider with respect to this second charging air flow, until ultimately the two charging air flows are released. In this way, the pressure surge present in known arrangements in the charging air line into the intake manifold is very advantageously avoided so that an abrupt build-up of torque which could overwhelm especially unskilled drivers of very high performance vehicles is avoided. The charging pressure of the charging air flows in the intake manifold and the amount of charging air increase rather gradually, as a result of which also a gradual build-up of torque in the internal combustion engine takes place. A sudden pressure surge or an unwanted pressure irregularity therefore does not arise. Likewise, the air damper can be designed such that it opens gradually, but completely within a very short time. In this way, the dynamics of the internal combustion engine are not adversely affected. Rather due to the opening of the air damper which begins from the start differently than with simple nonreturn valves, no delay as a result of the hysteresis of the nonreturn valve can be observed, but torque builds up with the starting of the second compressor.

In other embodiments one charging air cooler is connected downstream to at least one of the compressors.

Preferably, a common charging air cooler is connected downstream from the compressors, especially preferably the valve being made structurally integral with the charging air cooler. The valve is made in particular external to the charging air coolers, or also on an inside wall, i.e., integrated in the charging air cooler or its housing. In this way, a very advantageous modular arrangement is achieved which entails operational assembly, installation space, and cost advantages.

In another preferred embodiment, at least one exhaust gas line has a bypass to the turbine which can be controlled preferably by a bypass valve. This bypass, which can preferably be controlled by a bypass valve, makes it possible to adjust the delivery of the exhaust gas mass flow of the exhaust gas line to the turbine by some of the exhaust gas mass flow being routed past the turbine, if the bypass valve opens.

In another preferred embodiment, the bypass bridges the first turbine of the first exhaust gas line which is assigned to the first exhaust valves. The bypass is accordingly located parallel to the first turbine that is located in the first exhaust gas line which is assigned to the first exhaust valves. This is the turbine which is always supplied with exhaust gas regardless of the operation of the second turbine (in the second exhaust gas line and thus assigned to the second exhaust valves), and its running behavior can be influenced by the bypass. In particular, it is thus possible to adapt the operating behavior of the first turbine to the starting of the second turbine which is assigned to the second exhaust gas line with the second exhaust valves, and thus the delivery rate of the connected compressor.

Furthermore, a method for operating an internal combustion engine is proposed, in particular according to one or more of the above described embodiments, the internal combustion engine having at least one cylinder which has at least two exhaust valves which are connected to the exhaust gas lines in which the turbines of exhaust gas turbochargers are located which have compressors for the charging air of the internal combustion engine. Here provision is made such that downstream from the compressor the charging air flows of the compressors are merged and that at least downstream from one of the compressors and upstream from the merge, externally controllable blocking or choking of at least one of the charging air flows can take place. The blocking, opening or choking of at least one of the charging air flows hence takes place externally controlled, not by way of the internal pressure conditions in the charging air line.

In one preferred version of the method, external control of the valve takes place via a software function, in particular of the engine control device of the internal combustion engine. Modern internal combustion engines known from the prior art are controlled with respect to their management depending on the operating states by means of engine control devices. Control of the valve can be very advantageously implemented by means of a software function in such engine control devices. A separate control device is thus unnecessary. In particular, this also ensures that by means of the software function the control of the valve can be completely integrated into the management of the internal combustion engine.

In another version of the process, the software function takes into account opening of only one or more exhaust valves of the internal combustion engine. The valve is thus controlled by means of the software function as a function of also at least the opening state of one or more exhaust valves of the internal combustion engine. If, for example, at an increased power demand the second exhaust valve of the respective cylinder is opened so that the exhaust gas of the internal combustion engine flows onto the second exhaust gas turbocharger and the compressor assigned to it delivers charging air, the valve is opened by the software function. In this way, at a sufficient charging air pressure from the second compressor the charging air flow is released in the direction of the intake manifold.

In another preferred version of the method, it is considered that the software function takes into account the charging air pressure in the intake manifold, in particular the charging air pressure upstream from the butterfly valve. In this way, that the charging air pressure desired upstream from the butterfly valve for operation of the internal combustion engine in a certain load state or at a torque demand is not reached or exceeded or fluctuates in some unwanted manner is very advantageously avoided. It is therefore possible to dynamically match the charging air pressure in the intake manifold, in particular specifically upstream from the butterfly valve, to the desired conditions. The software function in this connection undertakes control of the valve such that the second compressor to which the valve is assigned makes available a charging air pressure or charging air flow such that together with the charging air flow of the first compressor, the desired charging air pressure of the butterfly valve is set, especially in this connection dynamic control is possible which takes place without significant delay and thus allows very dynamic management of the internal combustion engine. In particular, the optimum instant for opening of the valve/damper can be determined and selected in this way.

In another version of the method, the software function takes into account an exhaust gas mass flow via at least one turbine and/or the charging air pressure downstream from at least one of the compressors. It is furthermore provided that the software function in one version of the method takes into account the oil temperature and/or coolant temperature, the intake air temperature and/or the charging air temperature. These parameters allow precision tuning of the valve opening or of blocking, release or choking of the charging air flow via the respective compressor assigned to the valve at the time, especially specifically the second compressor, depending on a plurality of operating states of the internal combustion engine. In particular, very differentiated management can be undertaken, which, with respect to the desired performance values and/or special energy efficiency of the internal combustion engine, optimizes management. In this way, the charging air flow can be specifically adapted very advantageously to the conditions prevailing at the time.

In one especially preferred version of the method, the software function takes into account those parameters, especially as described above, which are already available to the engine control device of the internal combustion engine. This means that for the software function for controlling the valve no additional sensors need be used, but that parameters are used which the engine control device of the internal combustion engine already processes anyway, which therefore originate, in particular, from the sensors already present for operation of the internal combustion engine, as is provided in the fundamental control and software architecture and the corresponding technical design of the engine control device of the internal combustion engine.

Especially preferably, the software function takes into account dead times or hystereses in the triggering of the valve. Operating delays as are present due to mechanical influences especially of the valve itself or an actuator which activates the valve, or an operating delay of a likewise desirable or undesirable type are considered by the software function, specifically either as given stipulated values, for example, also as values averaged for a certain series, are read out, for example, from a storage area and used in operation, or are determined by the software function, depending on the management of the valve, and stored for further use and then used. In this connection, starting delays of compressors or delays in the build-up of torque of the internal combustion engine can be very advantageously compensated. For example, it is possible to keep the valve closed beyond a certain opening instant and then to open it rapidly, or, however, to open it continuously before the actually intended opening instant in order to slowly and continuously build up the pressure, if this is necessary or feasible in the management of the internal combustion engine.

In one preferred version of the method, the software function controls opening or closing of the bypass, in particular triggering of the bypass valve. The software function which controls opening and closing of the valve or the damper also controls the bypass here. Management thus is possible with respect to control of the valve and of the bypass, hence with respect to actuating the first turbine in order to achieve tuned operating behavior and very harmonic power development.

Preferably, triggering of the bypass valve takes place depending on whether one exhaust valve or two exhaust valves per cylinder are opened. In this way, especially irregularities in the operating behavior of the two turbochargers can be avoided, for example an unwanted pressure drop or unwanted pressure rise when the second turbine or the second turbocharger is started by releasing the second compressor when the second exhaust valves of the internal combustion engine are opened. The exhaust gas mass flow which is now driving the two turbines of the two turbochargers when both exhaust valves are opened and thus the two turbochargers of the two exhaust gas lines are exposed to exhaust gas, is set with respect to the portion of the first turbine by way of the bypass before or during opening of the second exhaust valves such that the operating behavior of the first turbine is controlled such that an irregularity in the charging air pressure build-up does not take place when the second exhaust valves open and the second turbine and second compressor are started.

In another preferred embodiment, the triggering of the bypass valve takes place depending on the mass discharge of exhaust gas into the exhaust gas lines for driving the turbines of the exhaust gas turbochargers. In this connection there is linkage to the detection of an exhaust gas mass discharge, not or not solely to the opening of the second exhaust valves. The objective here is also to avoid irregularities in the charging air pressure build-up.

Other advantageous embodiments will become apparent from the dependent claims and from combinations thereof.

The invention is detailed below using one exemplary embodiment, without being limited hereto.

The FIGURE shows an internal combustion engine with two exhaust gas turbochargers in two exhaust gas lines as well as a charging air merge with an externally controllable valve.

The FIGURE shows an internal combustion engine 1 with four cylinders 2, two exhaust valves 3 being assigned to each cylinder 2, specifically a first exhaust valve 4 and a second exhaust valve 5. Each first exhaust valve 4 is assigned to a first exhaust gas line 6 and each second exhaust valve is assigned to a second exhaust gas line 7. In each exhaust gas line 6, 7 there is a turbine 8 of an exhaust gas turbocharger 9, specifically, a first turbine 10 in the first exhaust gas line 6 and a second turbine 11 in the second exhaust gas line 7. The first turbine 18 in the first exhaust gas line 6 is assigned a bypass 12 with an adjustable bypass valve 13 for at least partially controllable bypassing of the first turbine 10. A first compressor 14 is further assigned to the first turbine 10 and a second compressor 15 is assigned to the second turbine 11, which supply charging air 16 to a charging air cooler 20 via an air filter 17 by way of a first charging air channel 18 or second charging air channel 19 at a time assigned to the first compressor 14 or the second compressor 15, the charging air flows 21 formed hereby being merged in an air merging space 22 which is made in the charging air cooler 20 and as a merge 23 of the charging air flows 21, from which the charging air flows which have been merged are supplied to an intake manifold 24 of the internal combustion engine 1. In the air merging space 22 there is an externally controllable valve 25 which is made as an air damper 26. Its triggering takes place by way of control electronics not shown here, in particular an engine control device of the internal combustion engine 1, the actuation of the air damper 26 taking place by way of an actuator which is not shown. The air damper 26 can block, release or partially release each individual one of the charging air flows 21 or can release both charging air flows 21 at the same time.

In operation of the internal combustion engine 1, it runs, for example, in low load and partial load operation with the second exhaust valve 5 closed, so that exhaust gas 27 is routed only by way of the first exhaust valve 4 to the first turbine 10. Operation of the first turbine 10 can be precisely adjusted by means of the bypass valve 13 here. In full load operation or with a sudden torque demand the second exhaust valves 5 are enabled, for example, by way of camshaft adjustment (not shown here) so that exhaust gas 27 of the internal combustion engine 1 is also supplied to the second turbine 11 by way of the second exhaust gas line 7. Accordingly, the second compressor 15 is started and likewise begins to deliver charging air 16 in the direction to the charging air cooler 20, in particular specifically to the merge 23. The air damper 26 is still closed here, so that the second compressor 15 works against the closed air damper 26. In this way, a charging air pressure from the merge 23 or the intake manifold 24 which charging air pressure arises from the fully operating first compressor 14 is prevented from leaking against the intended delivery direction to the second compressor 15 and from leading to an unwanted pressure drop or associated power loss of the internal combustion engine 1. Only when the second compressor 15 has attained a sufficiently high delivery rate and has built up a corresponding charging pressure in the second charging air guide 19, is the air damper 26 gradually, but very swiftly opened, so that the delivery rate of charging air 16 of the second compressor 15 travels into the merge 23 and is supplied by way of the charging air cooler 20 to the intake manifold 24 and ultimately to the combustion in the internal combustion engine 1. In this way, clean, gentle use of the second compressor 15 can be achieved which is not accompanied by a torque change which is unpleasant to the driver of a motor vehicle in which the internal combustion engine 1 is used. Rather, the charging pressure in the intake manifold 24 is built up gradually, but very swiftly, by the two compressors 14, 15, so that the dynamics of the internal combustion engine 1 is not adversely affected. Unwanted phenomena from known bi-turbo arrangements hereby are eliminated. Control of opening of the air damper 26 takes into account dead times or hystereses in order to prevent undesirably early opening or closing at an undesirable instant. In this connection, the control takes into account in particular a flag (not shown) which can be read out in the engine control device and which indicates whether one or more cylinders 2 are also forcing exhaust gas 27 out through the second exhaust valve 5 as the exhaust gas mass flow.

Furthermore, the pressure in the intake manifold 24 is preferably taken into account, for example the charging air pressure upstream from the butterfly valve which is not shown. In addition, the mass flow of charging air 16 which is delivered by way of the compressor 14, 15 is preferably taken into account, in particular by way of the second compressor 15, or the pressure downstream from the respective compressor 14, 15, and the pressure can also be computed from the aforementioned mass flow. In order to achieve harmonic operating behavior of the internal combustion engine 1, moreover, its further operating states are preferably considered, particularly the oil temperature or, by way of replacement, the coolant temperature, the intake air temperature or combinations of these temperatures. This allows not only harmonic management of the internal combustion engine, but especially also management which does not unduly burden the internal combustion engine 1 or its components. This results in the operation of the internal combustion engine 1 being especially reliable and in its service life being increased. The transition from the active first compressor 14 to the second compressor 15 which is operated in addition to the first compressor 14 can be optimized with respect to the torque build-up by the delivered charging air flows 21 by using the air damper 26. Furthermore, acceleration of the second turbine 11 and of the second compressor 15 which is coupled torsionally strong to it can furthermore be improved by controlled opening of the air damper 26, as described above.

### REFERENCE SYMBOL LIST

1 internal combustion engine
2 cylinder
3 exhaust valve
4 first exhaust valve
5 second exhaust valve
6 first exhaust gas line
7 second exhaust gas line
8 turbine
9 exhaust gas turbocharger
10 first turbine
11 second turbine
12 bypass
13 bypass valve
14 first compressor
15 second compressor
16 charging air
17 air filter
18 first charging air channel
19 second charging air channel
20 charging air cooler
21 charging air flow
22 air merging space
23 merge
24 intake manifold
25 valve
26 air damper
27 exhaust gas

1. An internal combustion engine with at least one cylinder which has at least two exhaust valves which are connected to exhaust gas lines in which there are the turbines of the exhaust gas turbochargers which have compressors for the charging air of internal combustion engines, characterized in that downstream from the compressors (14, 15) there is a merge (23) for the charging air flows (21) of the compressors (14, 15) and that there is at least one externally controllable valve (25) downstream from at least one of the compressors (14, 15) and upstream from the merge (23).

2. The internal combustion engine according to claim 1, characterized in that the valve (25) is made as an air damper (26).

3. The internal combustion engine according to one of the preceding claims, characterized in that the merge (23) has an air merging space (22) in which the valve (25) is located.

4. The internal combustion engine according to one of the preceding claims, characterized in that the valve (25) which is made as an air damper (26) is located in the air merging space (22).

5. The internal combustion engine according to one of the preceding claims, characterized in that the valve (25) which is made as an air damper (26) is located in the air merging space (22) such that selectively the charging air flow (21) coming from one compressor (14, 15) and the charging air flow (21) coming from the other compressor (14, 15) can be blocked or choked or that the two charging air flows (21) can be released.

6. The internal combustion engine according to one of the preceding claims, characterized in that a charging air cooler (20) is connected downstream from at least one of the compressors (14, 15).

7. The internal combustion engine according to one of the preceding claims, characterized in that a common charging air cooler (20) is connected downstream to the compressors (14, 15).

8. The internal combustion engine according to one of the preceding claims, characterized in that the valve (25) is made structurally integral with the charging air cooler (20).

9. The internal combustion engine according to one of the preceding claims, characterized in that at least one exhaust gas line (6, 7) has a bypass (12) to the turbine (10, 11), which bypass can be adjusted preferably by a bypass valve (13).

10. The internal combustion engine according to one of the preceding claims, characterized in that the bypass (12) bridges a first turbine of the first exhaust gas line (6) which is assigned to the first exhaust valves (4).

11. A method for operating an internal combustion engine, in particular according to one or more of the preceding claims, the internal combustion engine having at least one cylinder which has at least two exhaust valves which are connected to the exhaust gas lines in which turbines of exhaust gas turbochargers are located which have compressors for the charging air of the internal combustion engine, characterized in that downstream from the compressors the charging air flows of the compressors are merged and that at least downstream from one of the compressors and upstream from the merge, externally controllable blocking or choking of at least one of the charging air flows can take place.

12. The method according to claim 11, characterized in that external control of the valve takes place via a software function, in particular of the engine control device of the internal combustion engine.

13. The method according to one of the preceding claims, characterized in that the software function takes into account opening of only one or more exhaust valves of the internal combustion engine.

14. The method according to one of the preceding claims, characterized in that the software function takes into account the charging air pressure in the intake manifold, in particular the charging air pressure upstream from the butterfly valve.

15. The method according to one of the preceding claims, characterized in that the software function takes into account an exhaust gas mass flow via at least one turbine and/or the charging air pressure downstream from at least one of the compressors.

16. The method according to one of the preceding claims, characterized in that the software function takes into account the oil temperature and/or the coolant temperature, the intake air temperature and/or the charging air temperature.

17. The method according to one of the preceding claims, characterized in that the software function takes into account those parameters, in particular as described above, which are already available to the engine control device of the internal combustion engine.

18. The method according to one of the preceding claims, characterized in that the software function takes into account dead times or hystereses in the triggering of the valve.

19. The method according to one of the preceding claims, characterized in that the software function controls opening or closing of the bypass, in particular triggering of the bypass valve.

20. The method according to one of the preceding claims, characterized in that the triggering of the bypass valve takes place depending on whether one exhaust valve or two exhaust valves per cylinder are opened.

21. The method according to one of the preceding claims, characterized in that the triggering of the bypass valve takes place depending on the mass discharge of exhaust gas into the exhaust gas lines for driving the turbines of the exhaust gas turbochargers.
